(19) United States
(12) Patent Application Publication
(10) Pub. No.: US 2003/0235763 A1
(43) Pub. Date: Dec. 25, 2003

(54) Grid coating process for lead acid batteries

(76) Inventors: Jose E. Gonzalez, Fishers, IN (US); Rongrong Chen, Fishers, IN (US)

Correspondence Address: MARGARET A. DOBROWITSKY, DELPHI TECHNOLOGIES, INC., Mail Code: 480-414-420, P.O. Box 5052, Troy, MI, 48007-5052, US

(21) Appl. No.: 10/177,184

(22) Filed: Jun. 21, 2002

(51) Int. Cl. H01M 4/66; H01M 4/68; B05D 5/12; H01M 4/82

(52) U.S. Cl. 429/234; 429/245; 29/2; 427/126.3

(57) ABSTRACT

A positive current collector grid which has been coated with a grid coating of PbO₂ particles in a polyacrylic acid solution. Solution may also contain isopropyl alcohol or other polymers such as polyvinylpyrrolidone, polyethylene oxide, and polystyrenesulfonic acid in place of or in addition to polyacrylic acid. PbO₂ particles may be varied in size. Number of coatings may be varied. Coatings may be applied via a direct gravure method or sprayer method. Coated positive current collector grid may undergo drying process to remove some or all of the polyacrylic acid, other polymers and solvents, leaving a layer of close packed PbO₂ particles adhered to the surface of grid.

### RELATED APPLICATIONS

This application is related to U.S. patent application entitled “IMPROVED ELECTRODE,” assigned to common assignee of present invention, filed on Feb. 21, 2002, application Ser. No. 10/080,296, having attorney docket number DP-305,735 and hereby incorporated by reference in its entirety.

### BACKGROUND OF THE INVENTION

1. Technical Field

The present invention relates to processes for reducing corrosion of positive current collector grids of lead acid batteries by way of coating the grids.

2. Description of the Related Art

The lead sulfuric acid battery is well known in the art. The lead acid battery is composed of positive and negative plates immersed in a solution of sulfuric acid and water (for example, a 5M solution of H₂SO₄ [s.g. of 1.280]) and plate separators made of porous materials. Traditionally there are six sets of positive and negative electrode plates immersed in sulfuric acid solution, thereby making up six electrochemical cells. Each cell potential is approximately 2 volts. The individual positive and negative plates are connected in series, creating a total battery voltage of 12 volts. The positive and negative electrode plates are comprised of lead and/or lead alloy current collector grids. The active material of the positive current collector grid is a paste made from a reaction of leady oxide (partially oxidized lead powder) with sulfuric acid; the key component of the paste is electrically conductive PbO₂. The PbO₂ is reduced to PbSO₄ when the battery is in a discharge mode.

It is well known that the current collector grid of the positive plate of a lead acid battery is subject to a corrosion process in which the solid lead (Pb) of the grid reacts with the water from the sulfuric acid solution and is oxidized, as illustrated by the equation that follows:

Pb(s)+H₂O (l)→PbO(s)+2H⁺(aq)+2e⁻

The Pb of the positive grid is oxidized, creating a corrosion layer of PbO₂, PbO, and/or PbSO₄ between the positive grid and the active material. Which corrosion layer is created is dependent upon numerous factors, such as the metal composition and morphology of the positive grid, cycling conditions, temperature, and the pH of the sulfuric acid solution. Additionally, the positive grid can react with the sulfuric acid electrolyte to form pits through pores, cracks or holes in the corrosion layer. These pits reduce the physical contact between the grid and the active material, thereby reducing the electrical conductivity of the positive plate and the overall battery.

Cast positive grids and expanded positive grids have different morphologies, resulting in different corrosion layers. The cast grid surface contains a randomly oriented network of grains that provide equal mechanical strength in all directions and allow the expansion of the corrosion layer without creating cracks between the positive grid and active material interface in high temperature accelerated tests. The corrosion layer for such cast grids is generally PbO₂. Oriented expanded positive grids have an elongated grain structure that is very strong in the axial direction, but not as strong in the radial direction. (This is a result of the manufacturing process, in which the slits are made in the grid strip are stretched in a direction normal to the direction of the slits). In high temperature accelerated tests, a corrosion layer of poorly conducting PbO is formed between the expanded positive grid and the active material, thereby resulting in a loss of electrical conductivity. Because of an increase in the under-hood service temperature of vehicles and because the rate of the positive grid corrosion process increases with temperature, there is a need to reduce the corrosion layer formed between the expanded positive grid and the active material. Reduction of the insulative corrosion layer improves the contact between the grid and the active material, improving the electrical conductivity of the positive electrode plate and increasing the overall life of the battery.

Previous approaches dealing with positive grid corrosion have included modifying an alloy composition of the positive grid, as suggested in U.S. Pat. No. 6,114,067 issued to Knauer. Knauer suggests modifying the lead alloy with copper and silver, in addition to the conventional components of lead, calcium and tin. This solution however involves the use of additional, more costly metals, thereby increasing the complexity and cost of the grid manufacturing process.

Another process (although not prior art) involves electrochemically depositing PbO₂ particles on the current collector grid surface, as disclosed in patent application entitled “IMPROVED ELECTRODE,” having attorney docket number DP-305,735 referred to above. However, while this process appears to reduce positive grid corrosion, it increases processing time for lead acid batteries. Another challenge with this process is that it does not allow for flexibility as to the number of electrochemical depositions of PbO₂ coatings or the thickness of the coatings.

There is therefore a need for an improved process of reducing corrosion of positive current collector grids by coating the grids that minimizes or eliminates one or more of the problems set forth above.

### SUMMARY OF THE INVENTION

It is an object of the present invention to provide a solution to one or more of the above mentioned problems. In one aspect of the invention, a metallic grid is provided with a wet grid coating which coats the metallic grid, the grid coating comprising a mixture of polyacrylic acid and lead dioxide (PbO₂) particles for the grid, wherein the grid, coated with wet grid coating, is subjected to a drying process. The wet grid coating may further include isopropyl alcohol. The wet grid coating may be applied to the metallic grid via the direct gravure method or a sprayer method. The drying process evaporates the polyacrylic acid (PAA) and the grid is coated in a dry film of a dense, smooth layer of PbO₂ particles. The wet grid coating thickness (and the thickness of the resulting dry grid coating of PbO₂ particles) may vary, dependent upon several factors, such as the size of the PbO₂ particles used in the wet grid coating and the number of times the wet grid coating is applied to the grid. One advantage of this invention is the reduction of the positive grid corrosion of the grid that has been coated with the wet grid coating and then dried. Another advantage of this invention is the increased adhesion of the battery active material to the coated grid. The wet coated grid, when dried, has a remaining film of PbO₂ particles that serve as seed crystals to encourage the formation of PbO₂ during the active material formation phase.

In another aspect of the invention, a method for treating a positive current collector grid is provided, the method involving the steps of coating a positive current collector grid with a mixture of PAA solution and PbO₂ particles and drying the mixture-coated grid. Another advantage of this invention is that the coating process can be adaptable to current manufacturing processes because of the speed with which it can be performed (as opposed to the alternative option of electrochemical deposition). A further advantage of using the wet grid coating technique is the flexibility with which the grid can be coated (i.e. the thicknesses can vary). One advantage of this method is it, can be adapted to a manufacturing process as it is not time consuming. Another advantage to this method is it allows flexibility to create varying thicknesses of the wet grid coating, by subjecting the grid to more than one application of the wet grid coating or by altering the composition of the grid coating, such as altering the size of the PbO₂ particles used.

A positive electrode plate for a lead acid battery is also provided, in which the plate includes at least one metallic grid that has been coated with a wet grid coating of a mixture of PAA and PbO₂ particles, and then subjected to a drying process, and active material covering the dried, coated grid.

Other features, objects, and advantages will become apparent to one of ordinary skill from the following detailed description and accompanying drawings illustrating the invention by way of example but not by way of limitation.

### BRIEF DESCRIPTION OF THE DRAWINGS

FIG. 1 is a perspective view of a battery of a type that can include the current collector grid according to the invention.

FIG. 2 is a perspective view of a positive electrode plate at various coating stages according to the invention.

FIG. 3 is a flow chart of the method according to the invention.

### DETAILED DESCRIPTION OF THE INVENTION

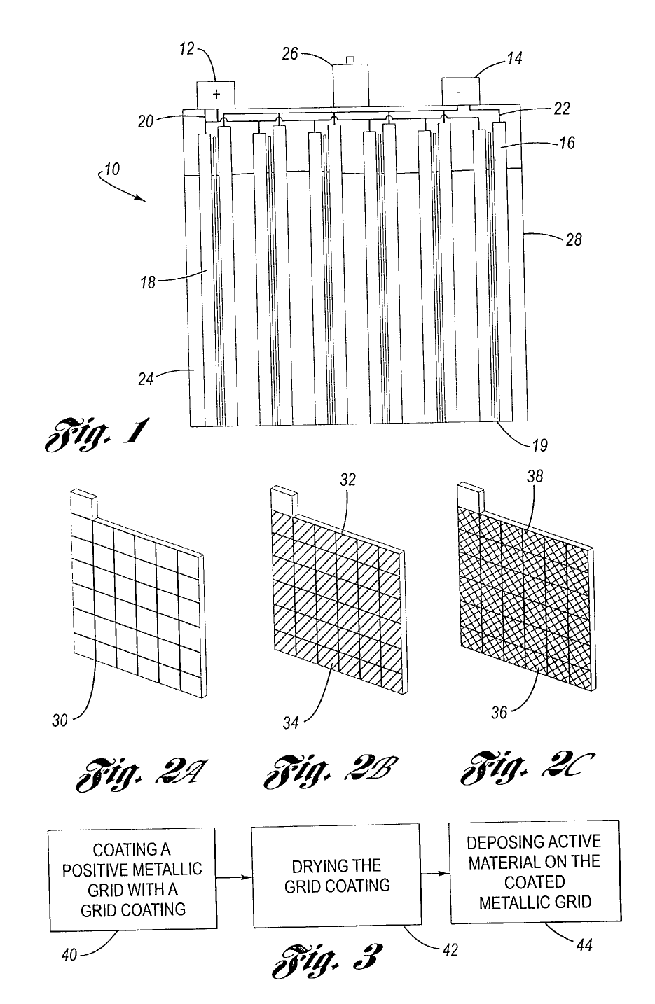

Referring now to the drawings wherein like reference numerals are used to identify identical components in the various views, FIG. 1 illustrates a conventional lead acid battery 10. Components of battery 10 include a positive terminal 12, a negative terminal 14, positive electrode plates 18, negative electrode plates 16, synthetic porous separators 19, electrical connections 20 to connect positive electrode plates 18 in series, electrical connections 22 to connect negative electrode plates 16 in series, sulfuric acid solution 24, vent cap 26, and a case 28.

The design and operation of lead acid battery 10 is well known in the art. The anodic reaction that occurs at the positive electrode plates 18 is

PbO₂+4H⁺+SO₄²⁻+2e⁻→PbSO₄+2H₂O;

where PbO₂ of the active material is reduced to form solid lead sulfate, having reacted with the sulfate ion from the dilute sulfuric acid.

The cathodic reaction that occurs at the negative electrode plates 16 is

Pb+2H⁺+SO₄²⁻→PbSO₄+2H⁺+2e⁻;

where solid lead is oxidized to form solid lead sulfate, having reacted with the sulfate ion from the dilute sulfuric acid.

Positive plates 18 and negative plates 16 are connected in series by their individual terminals. The terminal of the end positive plate 18 connects all positive plates 18 to positive battery terminal 12. The terminal of the end negative plate 16 connects all negative plates 16 to negative battery terminal 14.

Creation of the inventive positive electrode plates 18 is illustrated in FIGS. 2A, 2B, and 2C. Each plate 18 contains a current collector bare grid 30, the inventive grid coating 34, and active material 36. FIG. 2A illustrates a current collector bare grid 30. Grid 30 is metallic and often a lead metal alloy. Pure lead grids can not hold their shape and do not have the mechanical strength necessary to support the active material placed on grid 30. The most widely used grid alloys fall into two categories—those that contain antimony and those that do not. Pb—Sb alloys may be used but are known to be prone to grid corrosion and to have low oxygen evolution potential and therefore are not as preferred as antimony-free alloys for grid 30. Antimony free alloys used for grid 30 may be Pb—Sn—Ca alloys and Pb—Sn—Ca—Ag alloys, among others commercially available. Pb—Sn—Ca alloys may be more preferable than Pb—Sn—Ca—Ag grids because silver is an expensive metal and grid alloys including noble metals such as silver have poorer active material adhesion.

The alloy compositions may vary. As to Pb—Sn—Ca grids, preferably, the alloy includes an upper weight percent of lead (Pb Wt %) of about 99.5, with an upper Pb Wt % of about 99 desired, and an upper Pb Wt % of about 98.5 more desired. A lower Pb Wt % of about 50 can be employed, with a lower Pb Wt % of about 90 desired, and a lower Pb Wt % of about 98.3 more desired. Also, the alloy includes an upper weight percent of tin (Sn Wt %) of about 5, with an upper Sn Wt % of about 3 desired, and an upper Sn Wt % of about 2 more desired. A lower Sn Wt % of about 0.5 can be employed, with a lower Sn Wt % of about 1 desired, and a lower Sn Wt % of about 1.4 more desired. In addition, the alloy includes an upper weight percent of calcium (Ca Wt %) of about 1, with an upper Ca Wt % of about 0.5 desired, and an upper Ca Wt % of about 0.1 more desired. A lower Ca Wt % of about 0.01 can be employed, with a lower Ca Wt % of about 0.05 desired, and a lower Ca Wt % of about 0.07 more desired. The most preferred alloy composition includes 98.5 wt % Pb, 1.5 Wt % Sn, and 0.08 Wt % Ca (Pb_{98.5}—Sn_{1.5}—Ca_{0.08}).

Grid 30 is the main route for current flow. Grid 30 may be formed by a variety of methods, including casting, punching and expanding metal, all known in the art. With a casting method, molten lead alloys are poured into molds. The punching method uses a die to cut a desired shape out of a lead alloy strip. The preferred method for making grid 30 is the use of expanded metal methods which involve making slits in a metal alloy strip and then stretching (i.e. expanding) the strip such that the desired grid shape is produced. The expanded metal grid technology is more efficient than the casting method for the mass production of standard plates for use in SLI (starting-lighting-ignition) batteries. Lighter grids are produced with the expanded grid method and there is no scrap material produced, as there is with the punching method.

As discussed above, the alloy composition of grid 30 and the surface morphology of grid 30 determine the morphology of the corrosion layer on the grid 30 surface due to the oxidation of the Pb in grid 30. The corrosion layer of a cast grid has a high PbO₂ content with radial cracks in the corrosion layer. The corrosion layer of an expanded grid which contains a dense, insulative layer of PbO at the interface between grid and active material, resulting in poor electrical conductivity. This PbO corrosion layer then exfoliates from grid surface, contributing to the corrosion of grid 30. By coating expanded grid 30, with wet grid coating 34 and subjecting it to a drying process, the corrosion process in which non-conductive PbO corrosion layer is reduced, active material 36 better adheres to grid 32, and electrical conductivity is improved between grid 32 and active material 36.

FIG. 2B illustrates a coated grid 32, having been coated with the inventive wet grid coating 34. Wet grid coating 34 is a “paint-like” mixture of PbO₂ particles and a polymer/solvent solution, such as liquid polyacrylic acid (PAA) solution. The mixture may also include isopropyl alcohol and may also include distilled water. The PbO₂ particles may vary in size; generally they are less than one micrometer. PbO₂ particles used may be α-PbO₂ (orthorhombic) or β-PbO₂ (tetragonal) crystals. α-PbO₂ crystals are preferred because the film that can be formed can be very high density that would reduce the grid corrosion and provide sufficient seed crystals for the formation of PbO₂ active material during the charging reaction. Other polymers may be used in the mixture in addition to or in place of PAA include polyvinylpyrrolidone (PVP), polyethylene oxide (PEO) and polystyrenesulfonic acid. The mixture may include 30-50 weight percent PbO₂ particles and 70-50 weight percent polymer/solvent solution, the mixture not to exceed 100 weight percent. In one embodiment, grid coating 34 comprises a mixture of 70 weight percent PAA solution and 30 weight percent PbO₂ particles.

Wet grid coating 34 may vary in thickness. This variance may arise in several ways. Increasing the concentration of PbO₂ particles in wet grid coating 34 results in wet grid coating 34 having a greater thickness. Alternatively, grid 30 may be subjected to a coating process several times. This results in several layers of wet grid coating 34, resulting in an overall greater thickness of wet grid coating 34.

Once wet grid coating 34 has been applied to grid 32, grid 32 is subjected to a drying process in which wet grid coating 34 is dried. Dependent upon the temperature and length of time to which grid coating 34 is subjected, the PPA and/or other polymers used and other solvent materials (such as isopropyl alcohol and/or distilled water) may be essentially removed completely. A remaining dry film of PbO₂ crystals coats coated grid 32. The thickness of the film of PbO₂ crystals may be in the range of 5 to 500 micrometers. The PbO₂ film may have a density of 9.5 to 9.8 g/ml and is relatively uniform in thickness throughout the grid.

FIG. 2C illustrates a completed positive electrode plate 38, active material 36 having been coated on coated grid 32 with dry grid coating of PbO₂ crystals. The steps involved in the creation of active material 36 are known in the art and are only briefly described herein. Traditionally, active material is formed by mixing leady-oxide powders with water and sulfuric acid and forming a paste. The paste may be coated onto coated grid 32 and then coated grid 32 may be steamed to facilitate crystal growth within the paste. The paste may then be cured through a number of reactions that take place within the paste and between the paste and coated grid 32. The curing produces a layer at the interface between coated grid 32 and paste that provides physical and electrical communication between active material and coated grid 32. In the forming step, the paste is converted to active material, which includes the electrically conductive PbO₂.

FIG. 3 illustrates an inventive method by which grid 30 may be treated. In first step 40, positive electrode grid 30 is coated with wet grid coating 34, creating coated grid 32. In next step 42, coated grid 32 is subjected to a drying process, in which grid coating 34 is dried. In step 44, active material is pasted on coated grid 32 (which involves any or all of the creation steps briefly discussed above).

Wet grid coating 34 may be applied via several methods. Grid 30 may be dipped into wet grid coating 34 for approximately one second; this process however is not the most effective or efficient method for obtaining a coat of PbO₂ particles on grid 30. A more effective method of applying grid coating 34 is by the use of a direct gravure coater. Use of a direct gravure coating process is well known in the art. Another method of applying grid coating 32 is via a sprayer method, also known in the art. Wet grid coating 34 thickness may vary, ranging from 0.1 micrometers up to and including 500 micrometers.

Coated grid 32 may be subjected to a drying process which can be performed at varying temperatures for varying lengths of time. Dependent upon the length of time and temperature of the drying process, varying amounts of PAA, or other polymers, and solvent are evaporated. Coated grid 32 may be fed through a heated oven. Electrical conductivity of grid 32 is improved if the PAA, other polymers, and solvents are removed completely, leaving only a dense, smooth film of substantially only PbO₂ particles. This may accomplished by increasing the drying temperature and/or length of time grid 32 is subjected to the drying process such that the PAA, other polymers, and solvents are essentially completely removed but the surface of grid 32 has not begun to melt and a film of PbO₂ particles remains on grid 32. To achieve minimum porosity of the resulting film of PbO₂ particles, the individual PbO₂ particles should be 500 nanometers such that close particle packing can exist.

While the invention has been disclosed in terms of specific embodiments thereof, it is not intended to be limited thereto, but rather only to the extent set forth hereafter in the claims which follow.

1. A current collector grid for a positive electrode of a lead acid battery, comprising:
a metallic grid; and
a wet grid coating coated on said metallic grid, said grid coating comprising a mixture of polyacrylic acid and PbO₂ particles, wherein said metallic grid, having been coated with said grid coating, is subjected to a drying process.

2. The grid of claim 1, said grid coating further comprising isopropyl alcohol.

3. The grid of claim 1, wherein said grid coating comprises a 50-70 weight % polyacrylic acid.

4. The grid of claim 1, wherein said grid coating comprises 30-50 weight % PbO₂ particles.

5. The grid of claim 1, wherein said metallic grid is a metal alloy.

6. The grid of claim 5, wherein said metal alloy is a lead-calcium-tin alloy.

7. The grid of claim 1, wherein the range of thicknesses for said grid coating is 0.1 micrometers up to and including 500 micrometers.

8. The grid of claim 1, wherein said PbO₂ particles are less than one micrometer in diameter.

9. The grid of claim 1, wherein said PbO₂ particles are essentially all α-PbO₂.

10. An improved positive electrode plate for a lead acid battery, comprising:
at least one positive electrode grid;
a wet grid coating comprising a mixture of polyacrylic acid and PbO₂ particles, wherein said wet grid coating is coated onto said grid and said grid is then subjected to a drying process; and
active material, said active material pasted on said dried, coated grid.

11. The plate of claim 10, said grid coating further comprising isopropyl alcohol.

12. The plate of claim 10, wherein said grid coating further comprises 50-70 weight % polyacrylic acid.

13. The plate of claim 10, wherein said grid coating further comprises 30-50 weight % PbO₂ particles.

14. The plate of claim 10, wherein said grid is a lead alloy.

15. The plate of claim 14, wherein said metal alloy is a lead-calcium-tin alloy.

16. The plate of claim 10, wherein the range of thicknesses for said grid coating is 0.1 micrometers up to and including 500 micrometers.

17. A method for treating a current collector grid of a positive electrode for a lead acid battery, comprising:
selecting one or more polymers from the group comprising polyacrylic acid, polyvinylpyrrolidone, polyethylene oxide, and polystyrenesulfonic acid;
coating a metallic grid with said a mixture of said selected polymer and PbO₂ particles; and
drying said mixture on said grid.

18. The method of claim 17 wherein said PbO₂ particles are less than one micrometer in diameter.

19. The method of claim 17 wherein said mixture further comprises isopropyl alcohol.

20. The method of claim 17 wherein said coating step is accomplished via a direct gravure method.

21. The method of claim 17 wherein said coating step is accomplished via a sprayer.

22. The method of claim 17, further comprising repeating said coating step.

23. A current collector grid for a positive electrode of a lead acid battery, comprising:
a metallic grid; and
a wet grid coating coated on said metallic grid, said grid coating comprising a mixture of one or more selected polymers and PbO₂ particles, wherein said selected polymers are selected from the group comprising polyacrylic acid, polyvinylpyrrolidone, polyethylene oxide, and polystyrenesulfonic acid,
wherein said metallic grid, having been coated with said grid coating, is subjected to a drying process.

24. The grid of claim 23, said grid coating further comprising isopropyl alcohol.

25. The grid of claim 23, wherein said grid coating comprises 50-70 weight % said selected polymer.

26. The grid of claim 23, wherein said grid coating comprises 30-50 weight % PbO₂ particles.

27. The grid of claim 23, wherein the range of thicknesses for said grid coating is 0.1 micrometers up to and including 500 micrometers.

28. The grid of claim 23, wherein said PbO₂ particles are less than one micrometer in diameter.
